(19) United States
(12) Patent Application Publication
(10) Pub. No.: US 2023/0363330 A1
(43) Pub. Date: Nov. 16, 2023

(54) SHOOT BINDER AND METHOD FOR STRAIGHTENING AND TYING SHOOTS OF PLANTS ARRANGED IN A LINEAR ROW

(71) Applicant: Clemens GmbH & Co. KG, Wittlich (DE)

(72) Inventor: Patrick CLEMENS, Wittlich (DE)

(73) Assignee: Clemens GmbH & Co. KG, Wittlich (DE)

(21) Appl. No.: 18/225,473

(22) Filed: Jul. 24, 2023

Related U.S. Application Data
(63) Continuation of application No. PCT/DE2022/100062, filed on Jan. 25, 2022.

(30) Foreign Application Priority Data
Jan. 25, 2021 (EP) 21153244.5

(51) Int. Cl. A01G 17/08

(52) U.S. Cl. CPC A01G 17/085

(57) ABSTRACT

A shoot binder for straightening and tying shoots of plants arranged in a linear row. A piece of holding equipment is attached to a work vehicle and can reach over the row. A straightening system straightens plant shoots protruding from the row, with at least part of the straightening system arranged on both sides of the row. A twine guiding device from which at least one twine element is unwound in order to restrain the shoots of the plants in a foliage wall on each side of the row. A connecting device performs a connecting operation for connecting the twine elements guided on both sides of the row.

This nonprovisional application is a continuation of International Application No. PCT/DE2022/100062, which was filed on Jan. 25, 2022, and which claims priority to European Patent Application No. 21153244.5, which was filed in Europe on Jan. 25, 2021, and which are both herein incorporated by reference.

### BACKGROUND OF THE INVENTION

### Field of the Invention

The present application relates to a shoot binder for straightening and tying shoots of plants arranged in a linear row, having the features of the preamble of claim 1, and a method for straightening and tying shoots of plants arranged in a linear row, having the features of the preamble of claim 8.

### Description of the Background Art

Shoot binders are known from the prior art of the relevant manufacturers. Basically, a shoot binder is intended for arranging elements of tree and/or row culture, for example a vine in a viticultural crop, by straightening and fixing the shoots on a trellis. Vines form shoots with foliage, with grapes also growing on these shoots. Due to their own weight, the shoots have a certain inclination in the lateral direction during growth, i.e., transversely to the longitudinal extension of the tree and/or row crop, the so-called row, which means that the grapes could then be below the leaves and be shaded, which can cause a delay in the ripening process of the grapes. However, the shoots to be straightened do not yet bear grapes.

In order to minimize this delay, the shoots and, accordingly, the foliage are straightened and positioned or fixed by inserting twine elements using the shoot binder. The twine elements should be connected at intervals to each other in order to properly position the straightened shoots. A connection of the twine elements is achieved by inserting a fastener such as a staple by means of a connecting device on the shoot binder. When connecting, i.e., binding, knotting or stapling the twine elements, care should be taken to ensure that no connecting operation takes place at certain locations, such as upon arriving at a stickel or in the case of dense foliage, so that the shoot binder and the vines are not damaged.

Furthermore, it is known from the state of the art that the connecting operation for connecting the twine elements is triggered manually by the driver. However, due to the fact that the driver has to greatly concentrate on the driving itself, i.e., the speed and position of the vehicle relative to the row of plants and is additionally occupied by the correct height adjustment of the shoot binder, the driver's reaction time when triggering the connecting operation can be further impaired, which can lead to a connecting operation being triggered at a location where this is not desired. This can cause damage to the shoot binder and/or the tree and/or row crop.

### SUMMARY OF THE INVENTION

It is therefore an object of the present invention to improve a shoot binder in such a way that the connecting operation is automatically carried out at a suitable location in the row.

Further, the object of the present invention is to provide a method for straightening and tying shoots of plants arranged in a linear row by means of a shoot binder, i.e., for carrying out the automatic connecting operation.

The core idea of the present invention is to provide a shoot binder for processing plants arranged in a linear row, in particular for straightening and tying shoots of tree and/or row crop forming a foliage wall by inserting and/or guiding at least two twine elements on different sides of the foliage wall by means of the shoot binder. The plant shoots are repositioned and held in the new position by the twine elements. Therefore, in a known manner, the shoot binder includes a straightening system for straightening the shoots. In addition, a connecting device is provided on the shoot binder, which is provided and designed to carry out a connecting operation for connecting the twine elements, in particular by means of fasteners. With the help of a suitably designed control device, the shoot binder can carry out the connecting operation automatically.

A connecting operation can be a stapling operation, i.e., that the connection of the twine elements is carried out by means of stapling elements. Such staples or stapling elements are sufficiently known from the prior art.

It should be noted that in the case of the shoot binder, a distinction should be made between a wire binding tool and a feed binding tool. With regard to the feed binder, a piece of string, for example, made of yarn made of different materials, is used as a twine element. In the case of a wire binder, the twine element is movably installed wire in the tree and/or row culture, which is interconnected by the wire binder.

According to the invention, it is provided that the connecting operation for connecting the twine elements is carried out automatically, i.e., that the connecting operation is triggered without any action on the part of the driver. The shoot binder is therefore preferably designed in such a way that the shoot binder automatically triggers a connecting operation at a suitable time and/or location.

It is also conceivable that the connecting operation can be triggered both automatically and manually, i.e., that the connecting operation can be triggered independently of the driver on the one hand and can be triggered manually by the driver on the other, should this prove to be useful.

By triggering and carrying out the connecting operation completely or mainly automatically, the driver can concentrate on the movement of the vehicle and the correct height adjustment of the shoot binder on the plant row. Furthermore, incorrect stapling is avoided, which can reduce the downtime caused by faulty staples, so that an overall increase in work performance is possible.

The connecting operation can be triggered or carried out at regular intervals.

This depends on the nature of the foliage wall and the arrangement of the plants in the row.

If the foliage wall is not particularly dense, for example, at the beginning of the growing season, the connecting operation can be triggered at a predetermined distance, for example, every 10 meters, preferably with a tolerance range of +2 meters/−2 meters.

If the foliage wall is already very dense, it is provided to trigger the connecting operation in a targeted manner, namely in an area with the lowest possible foliage density or in a gap in the foliage wall. Other provisions are also conceivable, such as a further shortened distance, which is less than 10 meters, or triggering the connecting operation after each stickel or the like.

A recognition device can be provided which is intended and designed to recognize a gap in the foliage wall of the tree and/or row crop, wherein the shoot binder comprises a control unit which is provided and designed to actuate the connecting device in such a way that, when the gap is recognized, a connecting operation is triggered near the gap. The recognition device may be located on the shoot binder or on a vehicle on which the shoot binder is arranged and to which the shoot binder is connected.

The term “gap” can be defined depending on the nature of the foliage wall density. A gap can be defined, for example, in that no obstacle, such as foliage, stickels or the like, has been detected in a detection range of the recognition device. A gap can also be understood to mean that there is as little foliage as possible in the detection range; this is particularly useful with a high density of foliage. A gap can have a limited extension in the vertical and/or longitudinal direction, for example 10 cm to 40 cm. It doesn't matter how deep the gap is across the row because a gap is only recognized if there is no obstacle. It is conceivable that the dimension in the vertical direction differs from the dimension in the longitudinal direction and accordingly has a different range of values. Alternatively, it is conceivable that the dimension in the vertical direction corresponds to the dimension in the longitudinal direction and accordingly has the same range of values.

The recognition device can be provided and designed to detect obstacles in order to prevent a connecting operation near the obstacles. This means that, in the best case, the recognition device can recognize a gap and an obstacle at the same time.

The recognition device can have a sensor which is designed and provided for recognizing the gap. Further preferably, the sensor is designed and provided for recognizing the gap or recognizing the gap and the obstacle.

It may also be preferable that obstacles, which are firmly installed in the crop, are measured such that their coordinates are known. For example, such obstacles can be stickels, further constraints or the like. The positions of the obstacles may be stored in a database, wherein the recognition device can access this database and accordingly does not trigger a connecting operation if such an obstacle is near the shoot binder. This range can be subject to tolerance. The positions of these obstacles can be determined, for example, by means of GPS, DGPS, RTK surveying, by entering reference locations, by means of geometric data by the driver or the like.

The sensor can be selected from a group comprising an ultrasonic sensor, a radar sensor, a camera system, a retro-reflective light switch, a Time Of Flight Sensor (ToF) sensor, or any combination thereof. These sensors are suitable for distance measurement, wherein any additional sensor that can be used for distance measurement is conceivable. Distance measurement can be used to detect whether or not an object is located in the respective detection range of the recognition device or sensor, or how dense the objects are in the detection range.

The sensor can be a camera system for generating an electronic, digital image file. For this purpose, an evaluation unit for evaluating the data of the camera system is preferred. Further preferred, the detection range of the sensor is transverse to the row, i.e., essentially at a 90° angle to it. It is also conceivable that the detection range is arranged at a different angle to the row than 90°, so that the sensor signal can be advanced and thus the area in front of the vehicle in the direction of travel is detected.

Alternatively, the sensor can be an ultrasonic sensor. Obstacles or gaps are reliably detected by means of the ultrasonic sensor.

The sensor can be disturbed in its functioning by the nearest row of tree and/or row culture or that there are insufficient criteria to recognize a gap. Therefore, according to a preferred embodiment, it may be provided that the recognition device comprises an opaque element, wherein the sensor is located on a first side of the foliage wall and the opaque element is disposed on a second side of the foliage wall, opposite the sensor.

Due to the opaque element, it is therefore possible to block out the disturbing neighboring row for the sensor. Likewise, the opaque element can serve as a reference for the sensor and for calibrating the sensor.

The opaque element can be a flat element, which means that the extension in two dimensions is significantly greater than in the third dimension. Preferably, the width and length are greater than the height of the flat element. In terms of size and arrangement of the opaque element, it is important that the main detection range of the sensor is covered by the opaque element.

The recognition device, i.e., in particular the sensor, can be arranged in advance of the connecting device as viewed in the direction of travel of the shoot binder. This is to detect the gap well in advance, so that the connection can be established exactly at the position that was detected in advance.

Being arranged in advance is therefore to be understood as meaning that the recognition device is located at a first distance in the direction of travel in front of the connecting device or, due to the position of the recognition device, is in front of the connecting device, therefore at an angle to it. The advantage of being arranged in advance is that the connecting operation does not have to be triggered at the exact moment a suitable location is recognized for triggering the connecting operation. This cannot be guaranteed in such a way due to delays in the system. When being arranged in advance, on the other hand, the system can react accordingly in time and precisely trigger the connecting operation.

A further core idea of the invention is to specify a method for straightening and tying shoots of plants arranged in a linear row by means of a shoot binder, in particular for straightening and tying shoots of the tree and/or row crop, wherein the shoot binder comprises a straightening system for straightening the shoots and a connecting device, wherein in the method the connecting device is automatically triggered.

Automatic triggering can be initiated in several ways:

According to a first example of a method for performing an automatic connecting operation of a shoot binder, the connection positions are determined by an image recognition system which identifies gaps in the foliage wall and which establishes the connection of the double-sided twine elements in these gaps by knots, staples or otherwise. Suitable gaps exist, for example, at the transition between stickels and neighboring plants or between two neighboring plants, i.e., in particular between two vines. This method variant is particularly suitable for those plant arrangements which, due to local conditions, are not arranged in a regular sequence of stickels and plants with uniform distances between them.

According to a second example, it is provided to automatically repeat a certain pattern of connecting processes in modern plant crops, which are usually erected at regular intervals between the neighboring stickels as well as at regular intervals between the vines. Such a pattern can be stored in a control program (software) implemented in the control device.

If a first fixed location in the row, such as the first stickel, is detected by the driver and the shoot binder or the work vehicle is next to it, the driver triggers the first binding operation. Further binding operations are then triggered automatically at predetermined intervals by continuously measuring the distance of the work vehicle from the specified fixed location, in particular by means of a position sensor on the work vehicle and/or by a GPS system. After reaching the paths defined in the program sequence or positions defined by coordinates, further connecting operations are automatically triggered, e.g., in the middle between neighboring stickels as well as just in front of and just behind a stickel.

In order to calibrate the program sequence again and again during processing, it makes sense to send a correction signal if there is a marking on the work vehicle or on the shoot binder near the stickel. This correction signal can be triggered manually by the driver.

Preferably, an image recognition system can be used for this purpose, which is optimized to recognize linear structures such as a stickel. As a result, the stickels in the row are automatically recognized and depending on the position of the automatically recognized stickel, the connection of the twine elements is carried out or the predefined sequence for connecting is automatically readjusted because of the position of the recognized stickel.

This is achieved through the use of a camera that covers a field of view in front of the shoot binder and an electronic image evaluation device that makes it easy to automatically detect simple geometric structures such as a stickel. On the one hand, this takes advantage of the fact that in viticulture and horticulture the plants are arranged linearly in the rows, so that only a linear path has to be followed, and on the other hand, that only straight, i.e., linear stickels are used, which are easily identifiable within the naturally grown, thus chaotic formation of the plants.

The advantageous further development of the method ensures that the shoot binder establishes a connection in front of or behind the stickel early enough, so that a collision with the stickel as well as any other obstacle is safely avoided.

The field of view captured by a camera contains at least a part of a row located in the direction of travel in front of the two components of the shoot binder, one of which is arranged on each side of the row during processing in order to be able to connect the two twine elements to each other. However, one or both components can also be in the field of view themselves.

A linear structure in the sense of the present invention is preferably, but not necessarily, a rectilinear structure. It can also be another structure, which is distinguishable from the chaotic structures of natural plant shoots.

The recognition of the linear structure can be carried out in such a way that it is specifically searched, recognized and tracked in the image range on the basis of previously carried out learning runs.

Indirect recognition is also possible by recognizing natural structures present in the image range, e.g., in plants based on the coloration of the foliage or other typical textures, and indirectly determining the linear structure by inversion, i.e., by filtering out all natural structures from the image.

According to a first option, the linear structure, once it is recognized as a stickel, is tracked by continuing the analysis for linear structures in the subsequent image recordings taken from the field of view in front of the processing devices. By comparing it with the data obtained from previous recordings, the progressive change in position of the stickel during the movement of the work vehicle can be tracked. As soon as the linear structure has reached a target mark or has completely left the image section, the connection can be triggered or the program sequence during binding can be automatically adjusted to the stickel that has been recognized as a fixed location.

It is also possible to calculate the inclination of the linear structure recognized as a stickel with respect to an image horizon or other reference plane, in particular its lateral inclination with respect to the longitudinal axis of the plant row. In addition, a stickel standing crooked laterally in the row can be recognized and the required distances of the binding locations before and after the stickel can be calculated in order to avoid a collision with the stickel even when it is inclined. It can also be recognized that a stickel is inclined in the longitudinal or row direction, i.e., inclined back against the direction of travel. In this case, the camera may detect that the upper section of the stickel has already been passed. However, the lower part can still protrude far enough for a collision with the equipment on the shoot binder to occur. Therefore, the pulse for the connection can be delayed as needed using the inclination detection.

The electronic camera is preferably arranged on a crossbeam of the piece of holding equipment, which reaches over the row.

Furthermore, according to the invention, a lateral attachment is preferred, in which the camera is positioned offset from the row in the single operation and faces the row vertically or obliquely from the side immediately in front of the processing devices, since in a lateral arrangement a larger extent of the linear structure can be detected by image recognition than in a view from above. In order for stickels to be reliably recognizable as linear structures in image evaluation, optical distortions are eliminated, especially when the camera is arranged sideways, especially if the camera is located only a short distance from the plant row. In order to be able to capture a sufficiently large image range at the given short distance, lenses with a small focal length must be used, which cause the distortions.

The distortion correction is preferably carried out mathematically on the recorded electronic image file before it is evaluated with regard to structure recognition. For this purpose, the recorded image is compressed concavely from the lateral edges, possibly also from the upper edge of the image and/or from the lower edge of the image. The compression factor can be adjusted in a calibration process while the camera is positioned at a stickel in the field of view. For this purpose, the orientation of the camera is first fixed during calibration and then the electronic image recorded above it is displayed to the operator before or during image evaluation. The horizontal and, if needed, vertical compression can be varied by the operator until the stickel is visible in the image as a linear structure and is recognized as such by the image evaluation algorithm implemented in the control device. Automated calibration is also possible by the operator positioning the work apparatus such that there is a stickel in the camera's field of view.

In order to distinguish between the stickels, which are oriented perpendicular or at an acute angle to the ground surface, and the trellis wires, which often run in the rows and parallel to the ground, it may be provided to determine the width of recognized linear structures and thus to distinguish between stickels and wires.

Inclination can be used as a further distinguishing criterion. If the detected angle of inclination of the linear structure with respect to the ground surface is more than about 45°, it is by definition a stickel, whereas linear structures that are approximately horizontal in the image section are to be identified as wires or binding devices belonging to the wires.

In addition to the stickels, which are always linear structures that reach to the ground, other image patterns of obstacles can be taught so that they are also recognized by the image recognition device and a control pulse for the connection is triggered. Such obstacles are, for example, the binding devices for the trellis wires.

In addition to the inline recognition of suitable connection positions, which are recognized and/or readjusted by sensors during the passage of the work vehicle through the row, additional or alternative georeferenced information can also be retrieved from databases stored in the memory unit of the control device or on an external storage medium that can be accessed online by means of a data connection. In addition to connection and obstacle positions, this information can also contain additional information on the properties of the plants present in the respective row, e.g., in order to automatically reduce or increase the number of connection locations depending on plant age or location.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a state-of-the-art shoot binder;

FIG. 2 is a rear view of the shoot binder according to FIG. 1;

FIG. 3 is a shoot binder on a work vehicle in schematic representation;

FIG. 4 shows a work vehicle between two rows of a vineyard in a schematic view from above;

FIGS. 5 and 6 each show the work vehicle in a row as shown in FIG. 4;

FIG. 7 is a block diagram of a control device; and

FIG. 8 is a camera shot.

### DETAILED DESCRIPTION

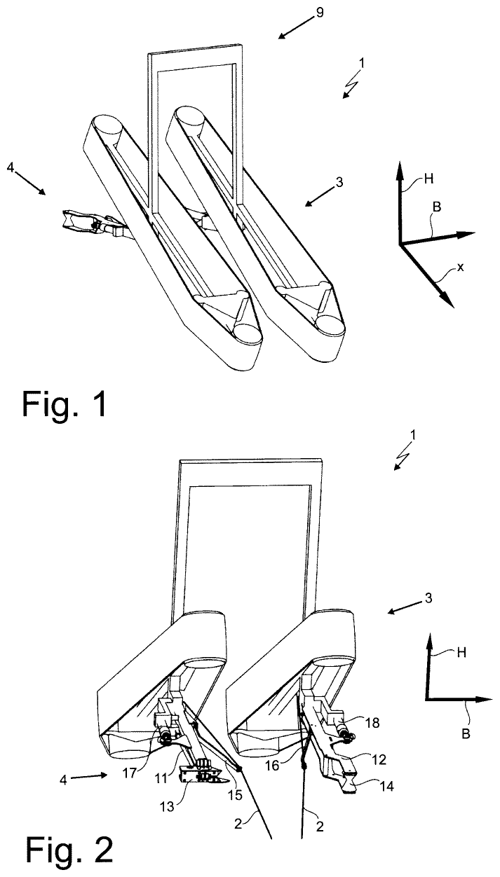

FIG. 1 shows a shoot binder 1 in a perspective view from the front, wherein the shoot binder 1 has a two-part straightening system 3 for straightening shoots of tree and/or row crops. The straightening system 3 has endless, circumferential belts, which are aligned upwards from the front bottom to the rear top when viewed in the direction of travel. Furthermore, the shoot binder 1 includes a connecting device 4. In addition, the shoot binder 1 has a base element 9 with which it can be arranged on a lift mast 10 of a work vehicle. The U-shape of the base element 9 allows for the entire arrangement with straightening and connecting systems to be guided above a row, wherein a part of the straightening system 3 and the connecting device 4 are arranged on each side of the row.

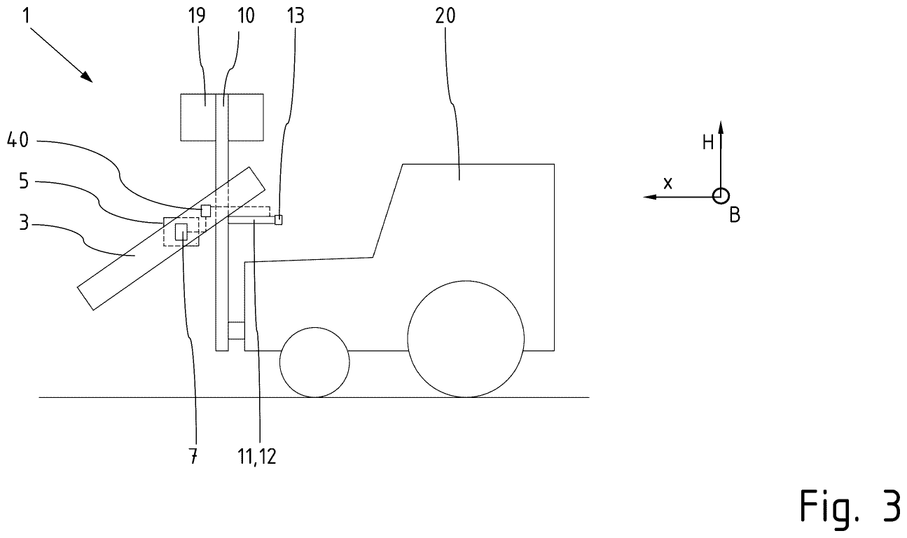

The shoot binder 1 is shown in detail in FIG. 2 in a perspective rear view. The connecting device 4 is provided and designed to carry out a connecting operation for connecting twine elements 2 by means of fasteners such as staples. It essentially comprises: a first connecting arm 11 with a first twine element guide 15 and with an automatic connector 13, and a second lever arm 12 with a second twine element guide 16 and with a counterpart 14 to the automatic connector 13,

The twine elements 2 are guided via the twine element guides 15, 16 in such a way that they run close to each other and are directly located within the area of action of the automatic connector 13 and the counterpart 14. The counterpart 14 is shaped in such a way that a fastener can be inserted via the automatic connector 13 in such a way that the twine elements 2 can be connected to each other. The automatic connector 13, on the other hand, contains the fasteners and is designed to eject the fasteners in order to connect the twine elements 2 in combination with the counterpart 14.

The connecting arms 11, 12 can be moved in the width direction B, namely they can be rotated around a respective axis of rotation, so that the connecting arms 11, 12 are rotatably disposed on the straightening system 3. A movement of the connecting arms 11, 12 is achieved by means of a first actuator 17 and a second actuator 18, wherein the actuators 17, 18 are on the one hand hinged with the straightening system 3 and on the other hand hinged with the respective connecting arm 11, 12. When the respective actuator 17, 18 is actuated, its length is changed, and thus also the distance between its two pivot locations, so that the respective connecting arm 11, 12 is rotated around its respective axis of rotation.

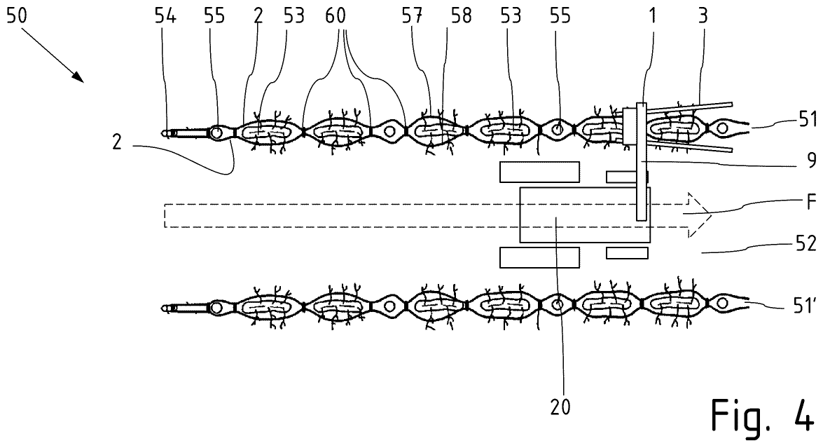

FIG. 3 shows the shoot binder 1 again in a schematic representation. Thus, FIG. 3 shows the recognition device 5 having a sensor 7 and the control unit 40, wherein the recognition device 5 is preferably arranged in the longitudinal direction x in front of the connecting device 4 and in particular in front of its automatic connector 13. In general, the longitudinal direction x can be understood as the direction of travel of a work vehicle 20 to which the shoot binder 1 is attached. The connection of the shoot binder 1 to the work vehicle 20 is established via a lift mast 10, through which the shoot binder 1 can be adjusted in height relative to the ground. A container 19 is provided, which contains a supply of twine elements 2.

The control unit 40 is in communication with the recognition device 5 at least by signaling, wherein the data of the sensor 7 can be transmitted to the control unit 40. The data obtained from the sensor 7 is then further processed in the control unit 40 in such a way that a triggering of the connecting operation is initiated when a corresponding gap has been detected. In order to control or trigger the connecting operation, the control unit 40 is at least in contact with the first actuator 17 and the second actuator 18 by signaling in order to bring about a change in the length of the actuators 17, 18.

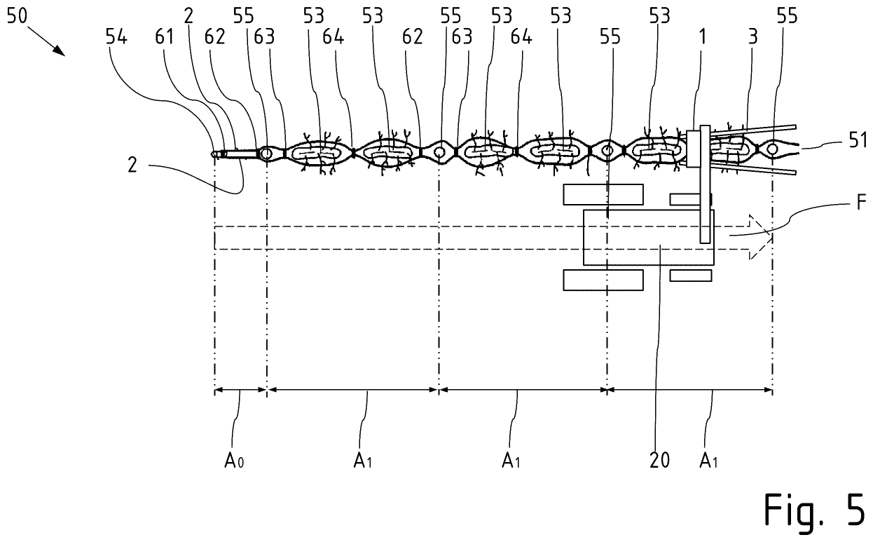

On the basis of the following FIGS. 4 to 6, a preferred embodiment of the method according to the invention is explained in more detail.

FIG. 4 schematically shows from above two rows 51, 51′ of a vineyard 50 with an intermediate operation 52. A large number of vines 53 are in linear arrangements, each forming a row 51, 51′. In each row 51, 51′ there are vertically oriented stakes, so-called stickels 55. At the beginning and end of each row there is another inclined stickel 54, over which the preload is applied to the wire trellises stretched between the stickels 55.

The work vehicle 20 with the shoot binder 1 travels in the direction of travel F, which is equal to the longitudinal direction x of the row, in the single operation 52 and processes the row 51 to the left of the vehicle 20. By means of the straightening systems 3 of the shoot binder 1, shoots protruding from the row 51 are led inwards from both sides. From the outside, a twine element 2 is pulled through the shoot binder 1 on both sides of the row 51 simultaneously, so that the shoots, when they spring out again after the shoot binder 1 is passed, are held back by the twine elements 2. Connecting the twine elements 2 running on both sides of the row 51 at the connection positions 60 ensures that the twine elements 2 are kept close to each other and thus close to the vines 3 and the wire trellises of the row 51.

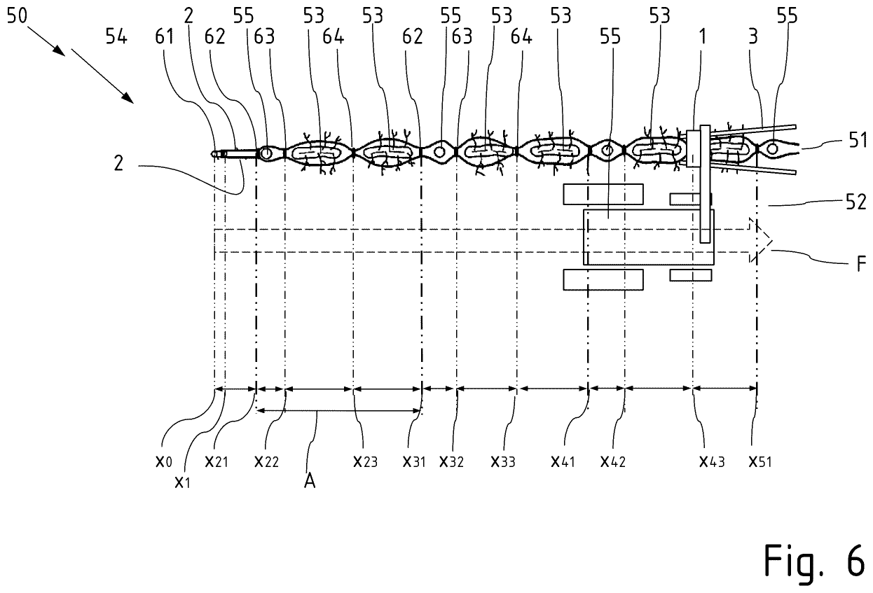

FIG. 5 shows the same row 51 as in FIG. 4, and the work vehicle 20 is also in the same position. With the dash-dotted lines, the direction of travel F is divided into several sections with different lengths A.

After an initial section with the distance A₀ between the inclined stickel 54 at the beginning and the first vertical stickel 55, several similar sections begin, each of which extends between two adjacent stickels 55 and each of which has a distance A₁ from each other. These distances A₁ were established when straightening the rows 51, 51′. They are therefore known or measurable and remain unchangeable. These known distances are used to create a connection sequence with several connection positions 60 for the respective row 51, 51′ as a program, which is stored in the control device.

At the beginning of the route F, the two twine elements 2 are attached to the initial stickel 54. The initial stickel 54 serves as a reference mark for the start of the program.

At the initial stickel 54, a first base connection of the twine elements 2 is established at a base connection position 61 by means of the shoot binder 1. Shortly in front of the first vertical stickel 5, a connection is established at a pre-stickel connection position 62 and behind it at a post-stickel connection position 63. In the illustrated embodiment of the method, an intermediate stickel connection position 64 is also provided, in which a gap between the vines 53 is used.

After that, the same pattern of connections begins again at the connection positions 62 . . . 64. By means of operator input of the distances A₀ and A₁, the control system is able to determine the positions for the recurring connections 62 . . . 64 automatically, temporarily store them in a memory unit and execute them at the intended location in the row 51.

For this purpose, for example, the pre- and post-stickel connection positions 62, 63 are set at the same distance from the stickel 55 on opposite sides of it. The distance to the stickel 55 is stored as a parameter in the memory unit of the control device, so that the connection positions 62, 63 are automatically calculated. The distance value can be changed by operator intervention.

The operator can also set the number of intermediate stickel connection positions 64. In the embodiment shown in FIG. 5, an intermediate stickel connection position 64 is specified in the middle between two neighboring stickels 55.

Once this sequence of connection positions 61 . . . 64 is programmed and stored in the memory unit of the control device, an automated procedure can be carried out by means of the single operation 52 when the work vehicle 20 passes through between the rows 51, by which single operation the connection positions 61 . . . 64 are automatically approached and a connection is established between the two twine elements 2 at the designated locations.

The programmed pattern of the connections is shown in FIG. 6, wherein the illustration of the upper row 51 is otherwise unchanged from the representation in FIGS. 4 and 5. The direction of travel F along the row 51 is defined here as an x-coordinate.

At a starting location x₀, a start signal is emitted by the operator or by a sensor on the shoot binder to initiate the sequence and automatically process the sequence of connection positions during the passage of the work vehicle 20 with the shoot binder 1 by means of the single operation 52: For x₁, the start connection position is 61. For x₂₁ and x₂₂, the connections are made at the pre- and post-stickel connection positions 62, 63. The intermediate stickel connection position 64 is at x₂₃.

After that, the sequence of the connection positions 62, 63, 64 is repeated again and again and finally ends at that of an end-of-row position that corresponds to the start connection position 61 but is not drawn here. Similar connections occur at connection positions with the coordinates x₃₁, x₃₂, x₃₃ or x₄₁, x₄₂, x₄₃, etc., each of which is offset by the distance L from the corresponding connection position in the preceding sequence.

For the intermediate stickel connection position 64, the gap recognition described above can also be used. In this case, the pre-programmed positions x₂₃, x₃₃, x₄₃ for the intermediate stickel connection position 64 only serve as a trigger location for gap recognition, i.e., automatic gap recognition is activated from this location on and then automatically triggers a connection at the next detected gap.

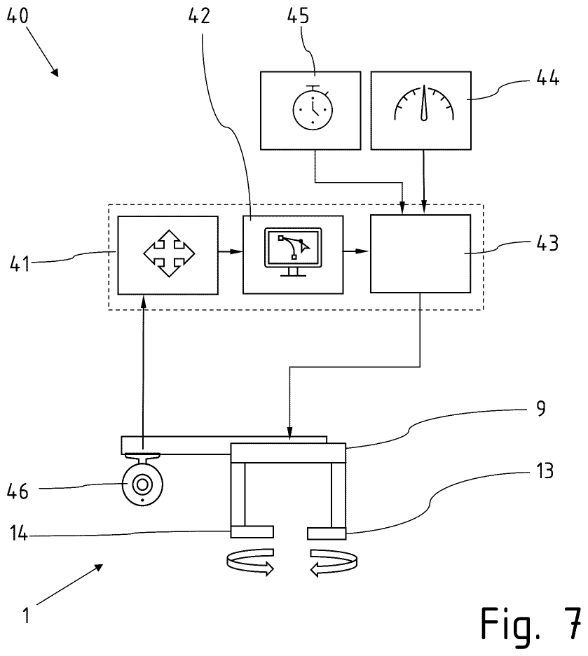

FIG. 7 shows in a schematic diagram the link between the work apparatus 10 and the control device 40. This comprises an image correction unit 41 with which, in particular, a compression or stretching of the field of view captured by the camera 46 and stored in an image file can be carried out in at least one dimension. The image thus corrected is checked for the presence of linear structures in an image recognition device 42. If this is detected, the actuators are actuated via a switching unit 43 in order to move the automatic connector 13 and the counterpart 14 toward each other and to carry out the connection of the twine elements. This control unit 40 also includes a speed sensor 44 and a timer 45, so that the distance between the work vehicle 20 and the associated shoot binder 1 can be determined by linking time and speed.

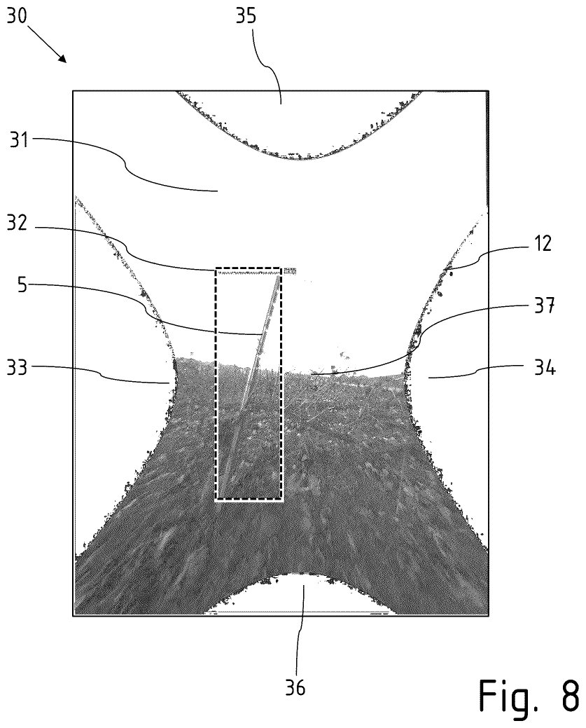

FIG. 8 renders the contents of an electronic image file 30 taken by the camera 46. The image range 31 has been corrected by horizontal and vertical compression zones 33, 34, 35, 36 in such a way that, for example, the image horizon 37 runs straight. As a result, a stickel 5 can be recognized as a linear structure, which is marked here with a marking 32 as a linear structure detected by the image recognition device 42.

The position of the detected stickel is used to readjust the sequence of connection positions stored in advance as a program in the control device:

The sequence of connection positions is conveniently related to the vertical stickel 55 (see FIG. 5), as already described above. This means that with the stickel 55 as the reference mark, the pre-stickel connection position 62 and the post-stickel connection position 63 are defined and starting from this with half the distance A₁, also the intermediate stickel connection position 64. If the work vehicle 20 with the shoot binder 1 now drives along the row 51, the field of view in front of it is electronically recorded and analyzed. It is true that the X-coordinates for each connection position have already been calculated in advance, as shown in FIG. 6. With the stickel detected by image recognition, a check can be triggered in the control device to determine the extent to which the theoretically predetermined coordinates of the next stickel correspond to the actually detected position, wherein the X-coordinate extending in the direction of travel F is generally sufficient for the position. If the difference between the predetermined position and the detected position is greater than a specified tolerance value, the control device recalculates all subsequent connection positions on the basis of the difference value. Thus, a continuous adaptation of the theoretically predetermined sequence of connection positions to the real conditions in the actually processed row in the vineyard takes place. It makes sense to create a storage space in the control device for each processed row and to replace the theoretically determined positions in it with the actually recognized positions. In addition, individual manual connections triggered by the operator can be registered and are available for later runs.

In the same way that approximately perpendicular stickels 55 can be used as reference marks to initiate readjustment via image recognition, the image recognition described above can also be used to detect obstacles in order to define obstacle positions and to block the connecting operation in the area where the obstacles are positioned. The obstacles can be, for example, overturned, bent or inclined stickels.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A shoot binder to straighten and tie shoots of plants arranged in a linear row, the shoot binder comprising:
a piece of holding equipment attachable to a work vehicle, which can reach over the row;
a straightening system for straightening plant shoots protruding from the row with at least part of the straightening system arranged on both sides of the row;
a twine guiding device from which at least one twine element is unwound to restrain the shoots of the plants in a foliage wall on each side of the row;
a connecting device to carry out a connecting operation for connecting the twine elements guided on both sides of the row; and
a control unit to identify suitable connection positions in the row located in front of the work vehicle in a direction of travel and, at the identified connection positions, operate the connecting device such that an automatic connecting operation of the twine elements is carried out, and/or store a program with a sequence of connection positions for the respective row, start the program on the basis of at least one reference mark identifiable in the row and operate the connecting device when the respective connection position is reached.

2. The shoot binder according to claim 1, wherein the control unit comprises or is connected to at least one recognition device comprising at least one sensor for recognizing at least one gap in a section of the foliage wall located in front of the shoot binder.

3. The shoot binder according to claim 2, wherein the recognition device is arranged in front of the connecting device as viewed in the direction of travel.

4. The shoot binder according to claim 1, wherein the recognition device is provided and designed to recognize an obstacle to the connecting device present in the row and to prevent a connecting operation near the obstacle.

5. The shoot binder according to claim 2, wherein the sensor is an image sensor and wherein the recognition device comprises at least one image recognition device for recognizing a gap in the row by means of the image data recorded by the image sensor.

6. The shoot binder according to claim 1, wherein the sensor is arranged on a first side of the row and wherein on a second side of the row, opposite the sensor, an opaque element is arranged in the detection range of the sensor.

7. The shoot binder according to claim 1, wherein the control unit comprises a memory unit in which suitable connection positions and/or obstacle positions in the row are stored.

8. The shoot binder according to claim 7, wherein the control unit comprises an operator interface via which at least one reference mark for determining a first connection position and at least one distance value or several coordinates are stored in the control unit to define further subsequent connection positions.

9. The shoot binder according to claim 8, wherein the shoot binder has or is connected to at least one position sensor or a displacement sensor connected to the control unit, and wherein the control unit is designed to carry out an ongoing comparison of the location of the shoot binder in the row determined by the position sensor or the displacement sensor with the connection positions and/or obstacle positions stored in the memory unit and, when a connection position is reached, to trigger a connecting operation and to prevent any connecting operation when an obstacle position is reached.

10. A method for straightening and tying shoots of plants arranged in a linear row using a shoot binder, which comprises a straightening system for straightening the shoots and a connecting device for connecting two twine elements and is attached to a work vehicle, the method comprising:
driving the work vehicle with the shoot binder along the row while inserting and/or guiding at least one twine element on both sides of the plants arranged in the row;
connecting the twine elements via fasteners at several connection positions;
identifying suitable connection positions in the row located in the direction of travel in front of the work vehicle while the work vehicle is in motion and immediately connecting the twine elements at the identified connection positions; and
connecting the twine elements in each case when connection positions are reached, which are predetermined in a sequence of connection positions for the respective row.

11. The method according to claim 10, wherein a suitable connection position is identified by a control unit comprising or connected to at least one recognition device, which comprises at least one sensor for recognizing at least one gap in a foliage wall in a section of the row located in front of the shoot binder.

12. The method according to claim 11, wherein the sensor is arranged in front of the connecting device as viewed in the direction of travel or its detection range is oriented towards it.

13. The method according to claim 12, wherein via recognition device, an obstacle to the connecting device present in the row is recognized and the connecting device is locked until after the obstacle has been passed.

14. The method according to claim 10, wherein the sensor is an image sensor and wherein the recognition device comprises at least one image recognition device for recognizing a gap in the row by the image data recorded by the image sensor.

15. The method according to claim 10, wherein the sensor is arranged on a first side of the row and wherein on a second side of the row, opposite the sensor, an opaque element is arranged in the detection range of the sensor.

16. The method according to claim 10, wherein the sequence of connection positions in the control unit is automatically calculated before and/or during the travel of the working vehicle along the row, wherein the following is previously stored by an operator in the control unit:
at least one reference mark specifying a first connection position in the row; or
at least one distance value measured relative to the reference mark for the beginning and length of a recurring sequence of connection positions or several coordinates to specify further subsequent connection positions.

17. The method according to claim 16, wherein a stickel standing in the row is chosen as the reference mark for the beginning of a recurring sequence of similar connection positions, wherein the field of view in front of the shoot binder is recorded on an ongoing basis by an electronic camera, wherein that the electronic image data are checked for the presence of a linear structure corresponding to a stickel in an image recognition device, and wherein, via the control device, when a linear structure is detected, the connection positions are readjusted on the basis of the position of the respective stickel detected in the row.
